(19) United States
(12) Patent Application Publication
(10) Pub. No.: US 2025/0291745 A1
(43) Pub. Date: Sep. 18, 2025

(54) DIRECT CONNECT BETWEEN NETWORK INTERFACE AND GRAPHICS PROCESSING UNIT IN SELF-HOSTED MODE IN A MULTIPROCESSOR SYSTEM

(71) Applicant: NVIDIA CORPORATION, Santa Clara, CA (US)

(72) Inventors: Wishwesh Anil GANDHI, Sunnyvale, CA (US); Debajit BHATTACHARYA, San Jose, CA (US); Ravi Kiran MANYAM, Santa Clara, CA (US); Karan MEHRA, Cary, NC (US); Prithvi Reddy CHERABUDDI, San Jose, CA (US)

(21) Appl. No.: 18/605,518

(22) Filed: Mar. 14, 2024

(51) Int. Cl. G06F 13/16; G06F 12/0831; G06F 13/42

(52) U.S. Cl. CPC G06F 13/1652; G06F 12/0831; G06F 13/4221; G06F 2213/0026

(57) ABSTRACT

Various embodiments include techniques for performing data transfer operations via a direct interconnect between a network interface and a graphics processor in a multiprocessor system that also includes a central processing unit (CPU). The CPU communicates with the graphics processor via a dedicated high-bandwidth interconnect to the memory in the graphics processor and a second interconnect to the graphics processor for various utility functions. The network interface communicates with the graphics processor via an interconnect to the memory in the graphics processor. The interconnect between the network interface and the graphics processor does not impact the throughput of the high-bandwidth interconnect from the CPU to the graphics processor, thereby improving CPU to graphics processor performance. Further, the interconnect between the CPU to the graphics processor does not impact the throughput of the interconnect from the network interface to the graphics processor, thereby improving network interface to graphics processor performance.

### BACKGROUND

### Field of the Various Embodiments

Various embodiments relate generally to computer system architectures and, more specifically, to a direct connect between network interface and graphics processing unit in self-hosted mode in a multiprocessor system.

### Description of the Related Art

A computing system generally includes, among other things, one or more processing units, such as central processing units (CPUs) and/or graphics processing units (GPUs), one or more memory systems, and one or more networks. Processing units execute user mode software applications, which submit and launch compute tasks, executing on one or more compute engines included in the processing units. In operation, processing units load data from the one or more memory systems, perform various arithmetic and logical operations on the data, and store data back to the one or more memory systems. One of the ways the processing units can communicate with the memory systems is via a network interface card (NIC). The NIC provides an interface between the processing units and the memory systems over various network interface protocols, including Ethernet, Peripheral Component Interconnect Express (PCIe), and/or the like.

In computing systems deployed for high-performance datacenter, cloud computing, and/or other applications, NICs can communicate with GPUs for the purpose of sharing data, synchronizing phases of computation, initiating new work for the GPU, the NIC, other devices in the system, and/or the like. In some examples, NICs can communicate with GPUs via direct memory access (DMA) data transfers. Consequently, compute workloads in a computing system with many GPUs, CPUs, NICs, and/or other devices can benefit when the GPUs efficiently communicate with the NIC. In certain typical self-hosted system configurations, the NIC can communicate with the GPU via the CPU. The GPU can communicate with the CPU via multiple interconnects, such as a high-bandwidth chip-to-chip (C2C) interconnect for data transfer and a low-bandwidth interconnect, such as (PCIe), for performing configuration operations, control operations, register read and/or write operations, interrupt operations, and/or the like. The NIC can communicate with the CPU via a second low-bandwidth interconnect, such as (PCIe). In some examples, the bandwidth of the high-bandwidth C2C interconnect can have a throughput of up to ten times the throughput of the low-bandwidth interconnect. In a specific example, the high-bandwidth C2C interconnect can have a maximum throughput of approximately 640 gigabytes per second (GB/s) in each direction while the low-bandwidth interconnect can have a maximum throughput of approximately 64 GB/s in each direction. The NIC can communicate with the GPU via the combination of the low-bandwidth interconnect between the NIC and the CPU and the high-bandwidth interconnect between the CPU and the GPU.

One problem with this approach for data communication between a NIC and a GPU is that the throughput is limited to the lowest bandwidth interconnect. In some examples, the second low-bandwidth interconnect between the NIC and the CPU could be a fifth generation (Gen 5) PCIe interconnect that has a raw throughput of approximately 64 GB/s in each direction. The NIC can be upgraded to support a sixth generation (Gen 6) PCIe interconnect that has a raw throughput of approximately 128 GB/s in each direction. However, if the CPU is not similarly upgraded, the throughput between the NIC and the CPU is limited by the lower-bandwidth 64 GB/s Gen 5 PCIe interconnect on the CPU. Because NIC to GPU communications pass through the CPU, the throughput between the NIC and the GPU is likewise limited by the lower-bandwidth 64 GB/s Gen 5 PCIe interconnect on the CPU.

Another problem with this approach for data communication between a NIC and a GPU is that the high-bandwidth C2C interconnect between the GPU and the CPU is shared among multiple uses, including DMA communications between the NIC and GPU, input/output (I/O) communications between the CPU and GPU, data transfers between the GPU and system memory on the CPU, and/or the like. As a result, bandwidth of the high-bandwidth C2C interconnect that is consumed by the NIC reduces the available remaining bandwidth of the C2C interconnect for other purposes, leading to reduced performance.

As the foregoing illustrates, what is needed in the art are more effective techniques for data communications in a computing system.

### SUMMARY

Various embodiments of the present disclosure set forth a computer-implemented method for performing data transfer operations in a multiprocessor system. The method includes accessing, by a network controller, a first memory of a first processor via a first interconnect using a first address map. The method further includes accessing, by a second processor, the first memory of the first processor via a second interconnect using a second address map. The method further includes accessing, by the second processor, a second memory of the first processor via a third interconnect. With the method, the first interconnect is coupled to the third interconnect.

Other embodiments include, without limitation, a system that implements one or more aspects of the disclosed techniques, and one or more computer readable media including instructions for performing one or more aspects of the disclosed techniques, as well as a method for performing one or more aspects of the disclosed techniques.

At least one technical advantage of the disclosed techniques relative to the prior art is that, with the disclosed techniques, a NIC can communicate with a GPU via a direct interconnect at higher data transfer rates relative to conventional techniques where data between the NIC and the GPU is transferred via a CPU. Because the NIC transfers data directly to the GPU, the throughput is not constrained by a lower-bandwidth interconnect on the CPU. Further, because the NIC does not consume bandwidth of the interconnects on the CPU, the CPU can perform data transfers and other data operations at higher throughput relative to conventional techniques that share CPU interconnect bandwidth with NIC data transfers. These advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computing system configured to implement one or more aspects of the various embodiments;

FIG. 2 is a block diagram of a parallel processing unit (PPU) included in the accelerator processing subsystem of FIG. 1, according to various embodiments;

FIG. 3 is a block diagram of a general processing cluster (GPC) included in the parallel processing unit (PPU) of FIG. 2, according to various embodiments;

FIG. 4 is a block diagram of a system with a single NIC module and a single PPU module that have a direct interconnect, according to various embodiments;

FIG. 5 is a block diagram of a system with two NIC modules and two PPU modules that have direct interconnects, according to various embodiments; and

FIG. 6 is a flow diagram of method steps for transferring data between a NIC and a PPU, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

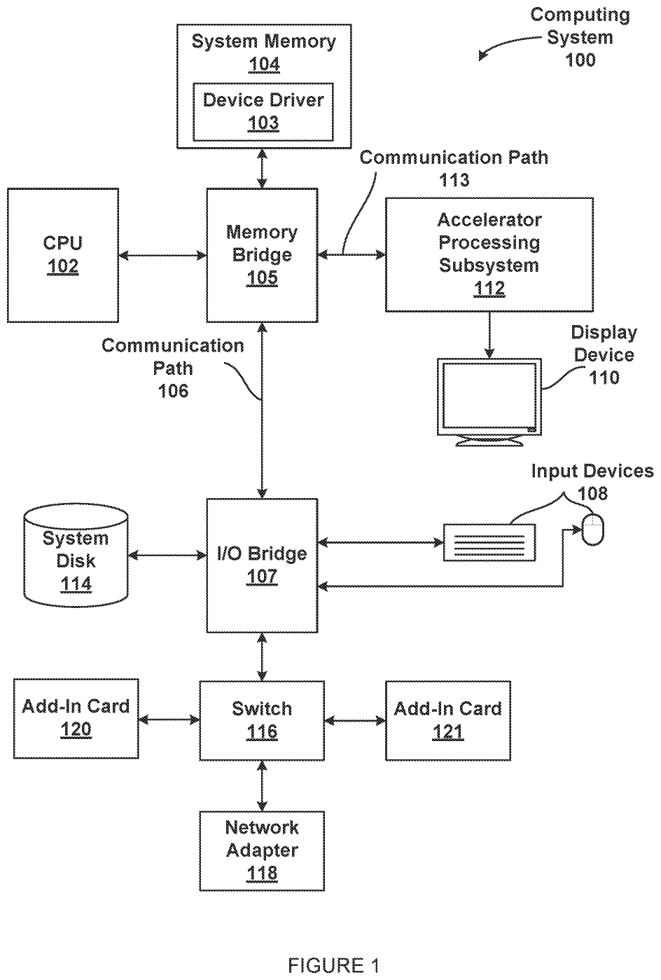

FIG. 1 is a block diagram of a computing system 100 configured to implement one or more aspects of the various embodiments. As shown, computing system 100 includes, without limitation, a central processing unit (CPU) 102 and a system memory 104 coupled to an accelerator processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. In some examples, input devices 108 are employed to verify the identities of one or more users in order to permit access of computing system 100 to authorized users and deny access of computing system 100 to unauthorized users. Switch 116 is configured to provide connections between I/O bridge 107 and other components of the computing system 100, such as a network adapter 118 and various add-in cards 120 and 121. In some examples, network adapter 118 serves as the primary or exclusive input device to receive input data for processing via the disclosed techniques.

As also shown, I/O bridge 107 is coupled to a system disk 114 that may be configured to store content and applications and data for use by CPU 102 and accelerator processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computing system 100, may be implemented using any technically suitable protocols, including, without limitation, Peripheral Component Interconnect Express (PCIe), HyperTransport, or any other bus or point-to-point communication protocol known in the art.

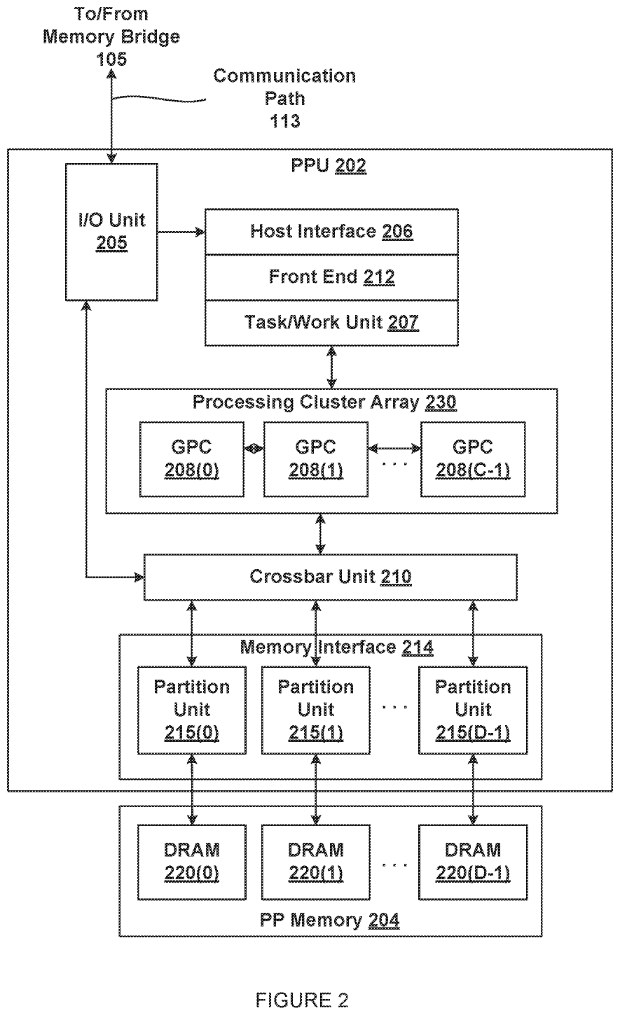

In some embodiments, accelerator processing subsystem 112 comprises a graphics subsystem that delivers pixels to a display device 110 that may be any conventional cathode ray tube, liquid crystal display, light-emitting diode display, or the like. In such embodiments, the accelerator processing subsystem 112 incorporates circuitry optimized for graphics and video processing, including, for example, video output circuitry. As described in greater detail below in FIG. 2, such circuitry may be incorporated across one or more accelerators included within accelerator processing subsystem 112. An accelerator includes any one or more processing units that can execute instructions such as a central processing unit (CPU), a parallel processing unit (PPU) of FIGS. 2-4, a graphics processing unit (GPU), a direct memory access (DMA) unit, an intelligence processing unit (IPU), neural processing unit (NPU), tensor processing unit (TPU), neural network processor (NNP), a data processing unit (DPU), a vision processing unit (VPU), an application specific integrated circuit (ASIC), a field-programmable gate array (FPGA), and/or the like.

In some embodiments, the accelerator processing subsystem 112 incorporates circuitry optimized for general purpose and/or compute processing. Again, such circuitry may be incorporated across one or more accelerators included within accelerator processing subsystem 112 that are configured to perform such general purpose and/or compute operations. In yet other embodiments, the one or more accelerators included within accelerator processing subsystem 112 may be configured to perform graphics processing, general purpose processing, and compute processing operations. System memory 104 includes at least one device driver 103 configured to manage the processing operations of the one or more accelerators within accelerator processing subsystem 112.

In various embodiments, accelerator processing subsystem 112 may be integrated with one or more other the other elements of FIG. 1 to form a single system. For example, accelerator processing subsystem 112 may be integrated with CPU 102, memory bridge 105, I/O bridge 107, and/or other components and connection circuitry on a single chip to form a system on chip (SoC). Additionally or alternatively, these various components can be integrated together on multiple chips in the form of chiplets and/or dielets. As referred to herein, chiplets and dielets are small integrated circuits, where each chiplet and dielet performs a defined set of functions. Multiple chiplets and dielets can be combined together to form a multi-chip module or hybrid integrated circuit that performs higher level functions. For example, multiple chiplets and dielets can be combined together to form computing system 100. Interconnect circuitry on the SoC, chiplets, and/or dielets, facilitates communication among the various components, including CPUs, GPUs, auxiliary processors, video and/or audio streaming devices, network adapters, and/or the like.

It will be appreciated that the system shown herein is illustrative and that variations and modifications are possible. The connection topology, including the number and arrangement of bridges, the number of CPUs 102, and the number of accelerator processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, accelerator processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the accelerator processing subsystem 112 of FIG. 1, according to various embodiments. Although FIG. 2 depicts one PPU 202, as indicated above, accelerator processing subsystem 112 may include any number of PPUs 202. Further, the PPU 202 of FIG. 2 is one example of an accelerator included in accelerator processing subsystem 112 of FIG. 1. Alternative accelerators include, without limitation, CPUs, GPUs, DMA units, IPUs, NPUs, TPUs, NNPs, DPUs, VPUs, ASICs, FPGAs, and/or the like. The techniques disclosed in FIGS. 2-4 with respect to PPU 202 apply equally to any type of accelerator(s) included within accelerator processing subsystem 112, in any combination. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computing system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. Additionally or alternatively, processors and/or accelerators other than CPU 102 may write one or more streams of commands for PPU 202 to a data structure. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computing system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computing system 100 may be varied. In some embodiments, accelerator processing subsystem 112, which includes at least one PPU 202, is implemented as an add-in card that can be inserted into an expansion slot of computing system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D≥1. Each partition unit 215 is coupled to one or more dynamic random access memories (DRAMs) 220 residing within PP memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPC 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity, and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within accelerator processing subsystem 112, or another accelerator processing subsystem 112 within computing system 100.

As noted above, any number of PPUs 202 may be included in an accelerator processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

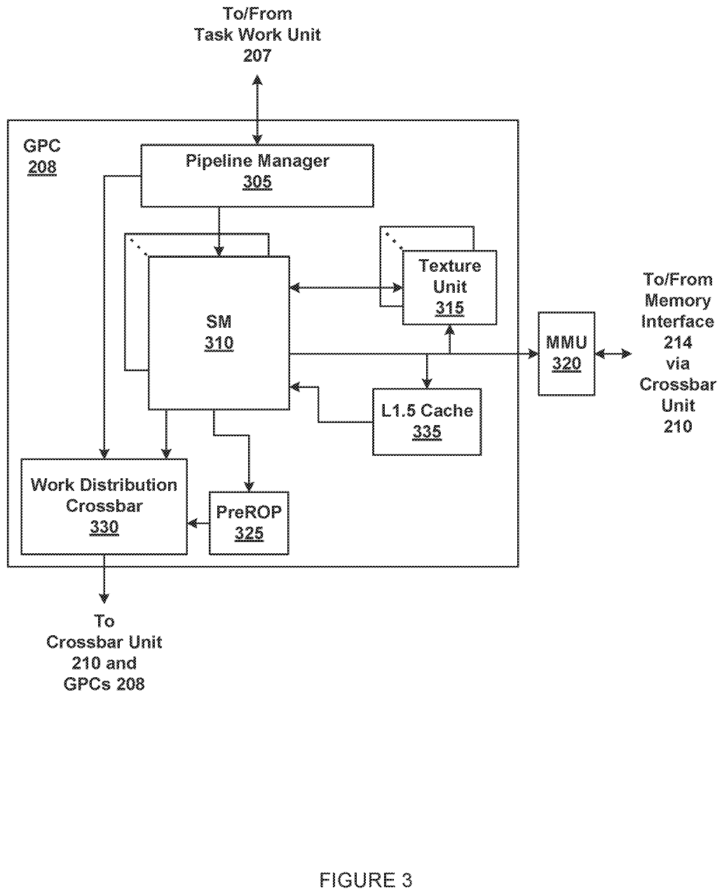

FIG. 3 is a block diagram of a general processing cluster (GPC) 208 included in the parallel processing unit (PPU) 202 of FIG. 2, according to various embodiments. In operation, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In one embodiment, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (e.g., AND, OR, XOR), bit-shifting, and computation of various algebraic functions (e.g., planar interpolation and trigonometric, exponential, and logarithmic functions, etc.). Advantageously, the same functional execution unit can be configured to perform different operations.

In operation, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within the SM 310, in which case some of the execution may be idle during cycles when that thread group is being processed. A thread group may also include more threads than the number of execution units within the SM 310, in which case processing may occur over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 310, and m is the number of thread groups simultaneously active within the SM 310. In various embodiments, a software application written in the compute unified device architecture (CUDA) programming language describes the behavior and operation of threads executing on GPC 208, including any of the above-described behaviors and operations. A given processing task may be specified in a CUDA program such that the SM 310 may be configured to perform and/or manage general-purpose compute operations.

Although not shown in FIG. 3, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, the SMs 310 may beneficially share common instructions and data cached in L1.5 cache 335.

Each GPC 208 may have an associated memory management unit (MMU) 320 that is configured to map virtual addresses into physical addresses. In various embodiments, MMU 320 may reside either within GPC 208 or within the memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In graphics and compute applications, GPC 208 may be configured such that each SM 310 is coupled to a texture unit 315 for performing texture mapping operations, such as determining texture sample positions, reading texture data, and filtering texture data.

In operation, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the core architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs. In view of the foregoing, persons of ordinary skill in the art will appreciate that the architecture described in FIGS. 1-3 in no way limits the scope of the various embodiments of the present disclosure.

Please note, as used herein, references to shared memory may include any one or more technically feasible memories, including, without limitation, a local memory shared by one or more SMs 310, or a memory accessible via the memory interface 214, such as a cache memory, parallel processing memory 204, or system memory 104. Please also note, as used herein, references to cache memory may include any one or more technically feasible memories, including, without limitation, an L1 cache, an L1.5 cache, and the L2 caches.

### Direct Connect Between Network Interface and Graphics Processing Unit in Self-Hosted Mode Store Operations

Various embodiments include techniques for performing data transfer operations via a direct interconnect between a network interface card (NIC), such as network adapter 118 of FIG. 1, and a graphics processor or other parallel processing unit, such as PPU 202, in self-hosted mode in a multiprocessor system. The NIC is also referred to herein as a network controller. The disclosed system includes at least one CPU, such as CPU 102 of FIG. 1, at least one PPU, and at least one NIC. The CPU includes a high-bandwidth C2C interconnect to the PPU for high-speed data transfer to and from memory in the PPU and a low-bandwidth interconnect for performing configuration operations, control operations, register read and/or write operations, interrupt operations, and/or the like. The NIC has also has an interconnect to the PPU for transfer to and from memory in the PPU. With this system configuration, the low-bandwidth interconnect from the CPU to the PPU and the interconnect from the NIC to the PPU can be coupled to the PPU via a switch. The low-bandwidth interconnect from the CPU to the PPU does not negatively impact the throughput of the interconnect from the NIC to the PPU. Further, the interconnect from the NIC to the PPU does not negatively impact the throughput of the high-bandwidth interconnect from the CPU to the PPU. With the disclosed techniques, the memory in the PPU can be addressed via two distinct page-table translations utilizing two distinct address maps, a first page-table translation utilizing a first address map employed by the CPU and a second page-table translation utilizing a second address map employed by the NIC. The disclosed techniques provide a PPU hardware-enforced coherency mechanism to resolve potential coherency issues resulting from accessing the memory in the PPU via two distinct page-table translations utilizing two distinct address maps.

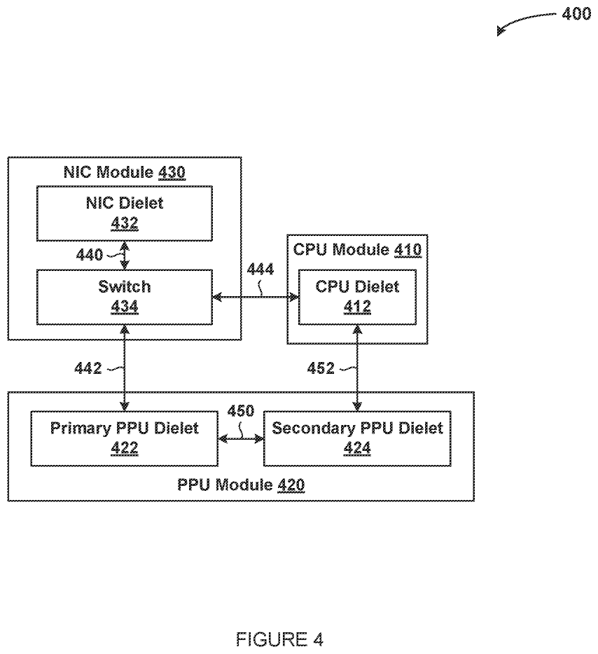

FIG. 4 is a block diagram of a system 400 with a single NIC module 430 and a single PPU module 420 that have a direct interconnect, according to various embodiments. System 400 includes, without limitation, a CPU module 410, a PPU module 420, and a NIC module 430. CPU module 410 includes, without limitation, a CPU dielet 412. PPU module 420 includes, without limitation, a primary PPU dielet 422 and a secondary PPU dielet 424. NIC module 430 includes, without limitation, a NIC dielet 432 and a switch 434. The components included in system 400 function substantially the same as similar components shown and described in conjunction with FIGS. 1-3 and as further described herein.

CPU dielet 412 includes a central processing unit, such as CPU 102 of FIG. 1. CPU dielet 412 can also include a system memory, such as system memory 104 of FIG. 1, as well as other components associated with the central processing unit, such as a system MMU (not shown), an I/O controller (not shown), and/or the like. CPU dielet 412 communicates with secondary PPU dielet 424 included in PPU module 420 via interconnect 452. Interconnect 452 is a high-bandwidth interconnect for high-speed data transfer between CPU dielet 412 and PP memory 204 included in PPU module 420. The PP memory 204 (not shown in FIG. 4) can be included in one or both of primary PPU dielet 422 and secondary PPU dielet 424. In some examples, interconnect 452 is a C2C interconnect with a throughput of approximately 640 GB/s in each direction. CPU dielet 412 communicates with switch 434 via interconnect 444. Interconnect 444 is a low-bandwidth interconnect for performing configuration operations, control operations, register read and/or write operations, interrupt operations, and/or the like. In some examples, interconnect 444 is a Gen 5 PCIe interconnect with a raw throughput of approximately 64 GB/s in each direction.

PPU module 420 includes primary PPU dielet 422 and secondary PPU dielet 424. The combination of primary PPU dielet 422 and secondary PPU dielet 424 compose one or more PPUs, such as PPU 202 of FIG. 2. Primary PPU dielet 422 and secondary PPU dielet 424 communicate with one another via a high-speed interconnect 450. As described herein, secondary PPU dielet 424 communicates with CPU dielet 412 over high-bandwidth interconnect 452 for high-speed data transfer between CPU dielet 412 and PP memory 204. Primary PPU dielet 422 communicates with switch 434 via interconnect 442. In some examples, interconnect 442 is a Gen 6 PCIe interconnect with a raw throughput of approximately 128 GB/s in each direction. Via interconnect 442, switch 434, and interconnect 444, CPU dielet 412 communicates with primary PPU dielet 422 for performing configuration operations, control operations, register read and/or write operations, interrupt operations, and/or the like. Via interconnect 442, switch 434, and interconnect 440, NIC dielet 432 communicates with primary PPU dielet 422 for performing data transfers between NIC dielet 432 and PP memory 204.

NIC dielet 432 includes a network adapter, such as network adapter 118 of FIG. 1. The network adapter is also referred to herein as a network controller. NIC dielet 432 communicates with one or more external systems (not shown) to facilitate data transfer between system 400 and the external systems. NIC dielet 432, in turn, performs data transfers between NIC dielet 432 and one or more other components of system 400. In so doing, NIC dielet 432 communicates with switch 434 over interconnect 440. In some examples, interconnect 440 is a Gen 6 PCIe interconnect with a raw throughput of approximately 128 GB/s in each direction. Via interconnect 440, switch 434, and interconnect 442, NIC dielet 432 communicates with primary PPU dielet 422 for performing data transfers between NIC dielet 432 and PP memory 204. Via interconnect 440, switch 434, and interconnect 444, NIC dielet 432 communicates with CPU dielet 412 for performing data transfers and various other operations.

Switch 434 provides connectivity and facilitates communication among the components of system 400. In some examples, switch 434 provides connectivity by bridging across various PCIe interconnects, such as interconnect 440, interconnect 442, and interconnect 444. Switch 434 can support interconnects of different generations, where the interconnects of different generations can have different maximum throughputs. For example, interconnect 440 and interconnect 442 can be Gen 6 PCIe interconnects, while interconnect 444 can be a Gen 5 PCIe interconnect. More generally, interconnect 440 and interconnect 442 can be PCIe interconnects of one generation with a higher throughput relative to interconnect 444. Correspondingly, interconnect 444 can be a PCIe interconnect of another different generation with a lower throughput relative to interconnect 440 and interconnect 442. When bridging interconnects of different generations, the resulting interconnect path is limited by the interconnect with the lowest throughput. In that regard, if switch 434 is bridging Gen 5 PCIe interconnect 444 with either Gen 6 PCIe interconnect 440 or Gen 6 PCIe interconnect 442, then the resulting interconnect path is limited to Gen 5 PCIe throughput. If, however, switch 434 is bridging Gen 6 PCIe interconnect 440 with Gen 6 PCIe interconnect 442, then the resulting interconnect path can achieve Gen 6 PCIe throughput.

In some conventional systems, when a NIC initiates a data transfer to PP memory in a PPU, the NIC can transmit DMA requests to PP memory via a PCIe interconnect, where such DMA requests follow PCIe ordering rules. In such conventional systems, these DMA requests to PP memory do not generate snoop operations, also referred to herein as probe operations or inquiry operations. Such snoop operations can determine if the CPU has currently checked out the portion of PP memory targeted by the DMA request. By checking out the portion of PP memory targeted by the DMA request, the CPU claims ownership or assignment of this portion of PP memory. In that regard, this portion of PP memory is considered to be owned by, or assigned to, the CPU. Without such snoop operations, the CPU and/or the NIC cannot coherently access PP memory. Therefore, incoming PCIe requests in such systems are conventionally transmitted on a particular virtual channel (VC) that does not generate snoop operations, but rather maintains PCIe write ordering to ensure coherency. This VC can also help to maintain certain quality of service (QoS) guarantees, by providing lower latency and higher bandwidth for certain PCIe requests, even under conditions of interference from PCIe requests generated by other PPU clients. However, such conventional systems, such as systems based on an x86 CPU architecture, lack a dedicated high-bandwidth C2C interconnect between the CPU and PP memory.

By contrast, CPU dielet 412 in the self-hosted system 400 of FIG. 4 routes data transfer traffic to PPU module 420 via high-bandwidth C2C interconnect 452. CPU dielet 412 routes other traffic, such as configuration operations, control operations, register read and/or write operations, interrupt operations, and/or the like, via low-bandwidth PCIe interconnect 444. In the dual-dielet configuration, where PPU module 420 includes primary PPU dielet 422 and secondary PPU dielet 424, CPU dielet 412 accesses PP memory 204 via a high-bandwidth C2C interconnect 452 to secondary

PPU dielet 424. NIC dielet 432 accesses PP memory 204 via a PCIe interconnect 442 to primary PPU dielet 422. As a result, PP memory 204 is accessible from both NIC dielet 432, via a PCIe base address register 1 (BAR1) address map, and CPU dielet 412, via a C2C host-managed device memory (HDM) address map.

Accessing PP memory 204 from two different dielets via two different address maps can lead to data incoherency when NIC dielet 432 and CPU dielet 412 concurrently access the same portion of PP memory 204. To prevent such data incoherency, hardware logic included in PPU module 420 includes a mechanism that ensures coherency between the simultaneous access from both the NIC dielet 432 and the CPU dielet 412 to the same portion of PP memory 204. A particular portion of PP memory 204, encompassing a range of physical memory addresses, can be coherently checked out by CPU dielet 412 when NIC dielet 432 generates a data transfer targeted to the same portion of PP memory 204. With the coherency mechanism in PPU module 420, if the data transfer generated by NIC dielet 432 reaches a cache memory for PP memory 204 when that portion of the PP memory is checked out by CPU dielet 412, then the cache memory controller generates a snoop operation. The cache memory controller transmits the snoop operation to a point of coherency included in CPU dielet 412. CPU dielet 412 generates a snoop response, also referred to as a probe response or an inquiry response, that includes the current data at the portion of the PP memory 204 targeted by NIC dielet 432. To ensure data coherency, the data transfer generated by NIC dielet 432 is not processed until the snoop response, including the current data, is returned. After receiving the snoop response from CPU dielet 412, the corresponding cache slice in the cache memory for PP memory 204 transmits to NIC dielet 432 any write acknowledgement, read response, atomic operation response, and/or the like corresponding to the data transfer.

By contrast, if the data transfer generated by NIC dielet 432 reaches a cache memory for PP memory 204 when that portion of the PP memory is not checked out by CPU dielet 412, then the data transfer can proceed without generating a snoop operation. Further, interconnects 440, 442, and/or 444 can preserve “write after write” (Wr-after-Wr) ordering of write operations included in data transfers generated by NIC dielet 432. Interconnects 440, 442, and/or 444 can preserve this Wr-after-Wr ordering, even when multiple write operations from NIC dielet 432 are directed to different cache slices in the cache memory for PP memory 204, and even when the corresponding memory addresses are checked out by CPU dielet 412.

If the data transfer generated by CPU dielet 412 is a strongly ordered write operation, indicating that strict write ordering should be enforced, then the cache memory controller: (1) waits until the snoop response, including the current data, is returned before generating and transmitting a write operation acknowledgement; and (2) maintains the portion of the PP memory 204 as checked out and interlocked until a transaction complete acknowledgment for the write operation is received from the PCIe ordering point. This mechanism enables the cache memory controller to support snoop operations from NIC dielet 432 or CPU dielet 412 memory operations on the incoming PCIe accesses in self-hosted mode.

In addition to this hardware mechanism, system 500 includes certain software-based techniques to support direct connect memory operations between NIC dielet 432 and PPU module 420 in self-hosted mode. These software-based techniques are discussed herein. In that regard, software executing on CPU dielet 412 can configure both NIC module 430 and PPU module 420 via Gen 5 PCIe interconnect 444 and switch 434.

Further, in a self-hosted system, PP memory 204 is exposed to CPU dielet 412 as a host-managed device memory HDM (HDM) address map, such that CPU dielet 412 can access PP memory 204 via C2C interconnect 452. However, with the disclosed direct-connect techniques, PP memory 204 is simultaneously exposed to NIC dielet 432 as a PCIe base address register 1 (BAR1) address map, such that NIC dielet 432 can access PP memory 204 via PCIe interconnects 440 and 442. In general, the BAR1 page-table mappings are not available in CPU dielet 412. As a result, NIC dielet 432 does not use the address translation service (ATS) to fetch the BAR1 page-table mappings from CPU dielet 412. Instead, when NIC dielet 432 accesses PP memory 204 via the BAR1 address map, a PPU device driver, such as device driver 103 of

FIG. 1, supplies the PP memory 204 BAR1 address directly to NIC dielet 432. Software stacks and other software applications can use these BAR1 page-table mappings when performing DMA operations and/or other data transfers to access PP memory from NIC dielet 432.

Note that the same physical memory address in PP memory 204 is available to NIC dielet 432 via BAR1 address mapping and to CPU dielet 412 via HDM address mapping, such as when NIC dielet 432 and CPU dielet 412 share access to a semaphore at a particular memory location. For these reasons, the cache memory controller supports check out of memory locations by CPU dielet 412 to the same memory address while simultaneously maintaining PCIe write-ordering for NIC dielet 432.

Unlike the restriction for NIC dielet 432 to not use ATS, PPU module 420 can operate in ATS mode, such as using ATS in conjunction with the CPU and system MMU included in CPU dielet 412. In some examples, PPU module 420 can use ATS to increase the utilization of the C2C bandwidth over interconnect 452. In general, the disclosed techniques can provide increased data bandwidth to PP memory 204 from NIC dielet 432 over interconnects 440 and 442, better utilization of C2C bandwidth over interconnect 452, and a hardware-enforced coherency mechanism to concurrently support both BAR1 address mapping and HDM address mapping to PP memory 204.

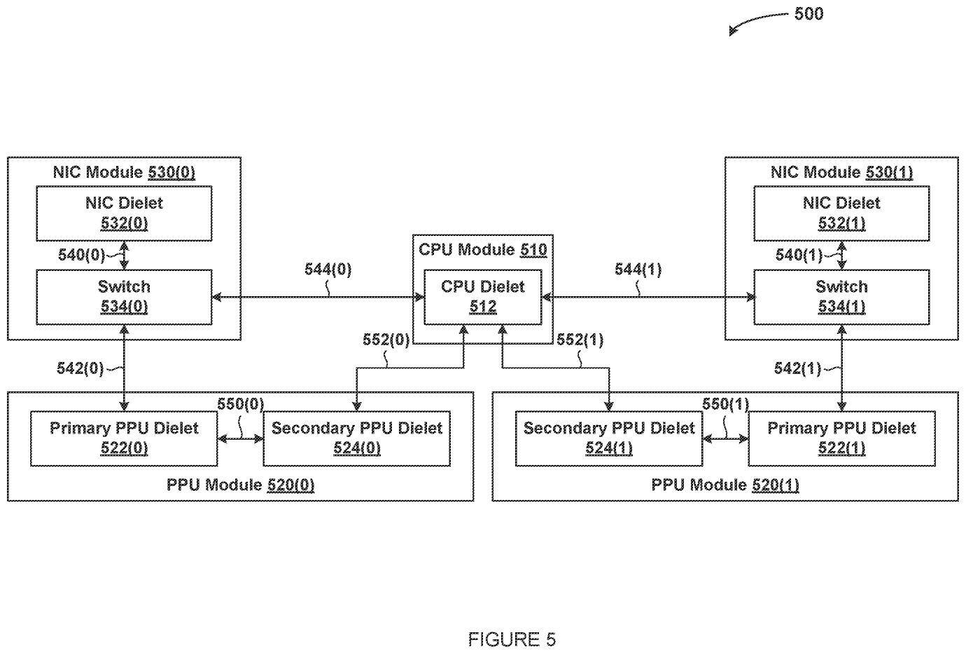

FIG. 5 is a block diagram of a system 500 with two NIC modules 530(0), 530(1) and two PPU modules 520(0), 520(1) that have direct interconnects, according to various embodiments. System 500 includes, without limitation, a CPU module 510, two PPU modules 520(0) and 520(1), and two NIC modules 530(0) and 530(1). CPU module 510 includes, without limitation, a CPU dielet 512. PPU module 520(0) includes, without limitation, a primary PPU dielet 522(0) and a secondary PPU dielet 524(0). Likewise, PPU module 520(1) includes, without limitation, a primary PPU dielet 522(1) and a secondary PPU dielet 524(1). NIC module 530(0) includes, without limitation, a NIC dielet 532(0) and a switch 534(0). Likewise, NIC module 530(1) includes, without limitation, a NIC dielet 532(1) and a switch 534(1). The components included in system 500 function substantially the same as similar components shown and described in conjunction with FIGS. 1-4 and as further described herein.

With the configuration shown in system 500, a single CPU dielet 512 included in CPU module 510 can communicate independently with multiple PPU modules 520 and/or multiple NIC modules 530 via dedicated interconnects. In that regard, NIC dielet 532(0) can communicate to primary PPU dielet 522(0) via interconnect 540(0), switch 534(0), and interconnect 542(0). CPU dielet 512 can communicate to NIC dielet 532(0) via interconnect 544(0), switch 534(0), and interconnect 540(0). CPU dielet 512 can communicate to primary PPU dielet 522(0) via interconnect 544(0), switch 534(0), and interconnect 542(0). CPU dielet 512 can communicate to secondary PPU dielet 524(0) via high-bandwidth interconnect 552(0). Primary PPU dielet 522(0) and secondary PPU dielet 524(0) can communicate with one another via high-bandwidth interconnect 550(0).

Similarly, NIC dielet 532(1) can communicate to primary PPU dielet 522(1) via interconnect 540(1), switch 534(1), and interconnect 542(1). CPU dielet 512 can communicate to NIC dielet 532(1) via interconnect 544(1), switch 534(1), and interconnect 540(1). CPU dielet 512 can communicate to primary PPU dielet 522(1) via interconnect 544(1), switch 534(1), and interconnect 542(1). CPU dielet 512 can communicate to secondary PPU dielet 524(1) via high-bandwidth interconnect 552(1). Primary PPU dielet 522(1) and secondary PPU dielet 524(1) can communicate with one another via high-bandwidth interconnect 550(1).

In this manner, a system 500 with a single CPU dielet 512 can support multiple high-bandwidth interconnects 552 to multiple PPU modules 520. Further, a system 500 with a single CPU dielet 512 can support multiple NIC modules 530, where each NIC module 530 has an independent interconnect path to a respective PPU module 520 included in the multiple PPU modules 520. Further, a single CPU dielet 512 can independently resolve data coherency issues with the different PPU modules 520 when the CPU dielet 512 and the NIC module 530 have access to the PP memory 204 in the respective PPU module 520 included in the multiple PPU modules 520.

It will be appreciated that the systems shown herein is illustrative and that variations and modifications are possible. A system that employs the disclosed techniques can have any number of CPU modules, PPU modules, and/or NIC modules. Each CPU module, PPU module, and/or NIC module can include any number of dielets, chiplets, and/or the like in any configuration. Each CPU module can include any number of CPUs, each PPU module can include any number of PPUs, and/or each NIC module can include any number of network controllers. The switches can be included in respective NIC modules as shown, included in one or more other modules in the system, and/or be included in a standalone switch module.

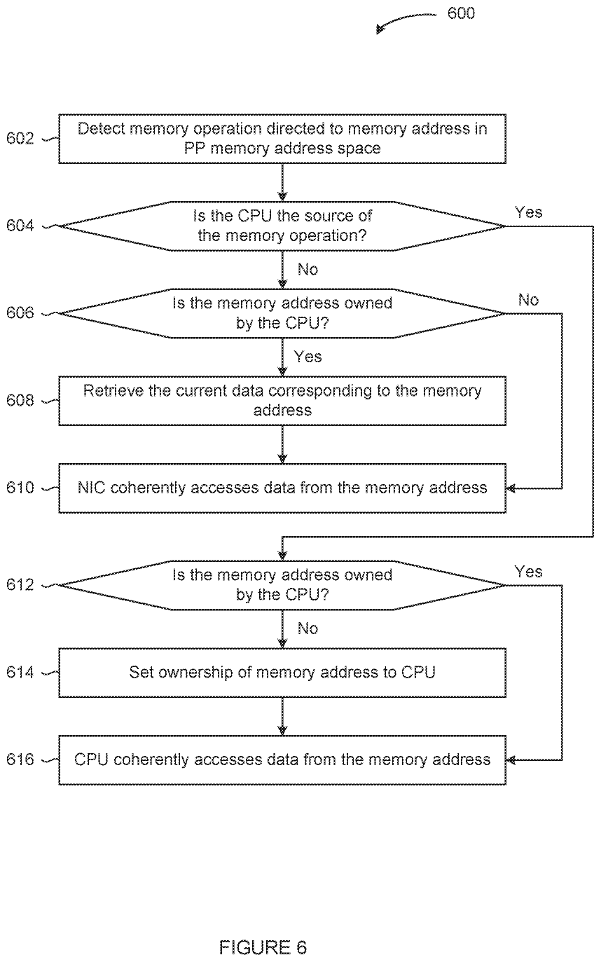

FIG. 6 is a flow diagram of method steps for transferring data between a NIC and a PPU, according to various embodiments. Additionally or alternatively, the method steps can be performed by one or more alternative accelerators including, without limitation, CPUs, GPUs, DMA units, IPUs, NPUs, TPUs, NNPs, DPUs, VPUs, ASICs, FPGAs, and/or the like, in any combination. Although the method steps are described in conjunction with the systems of FIGS. 1-5, persons of ordinary skill in the art will understand that any system configured to perform the method steps, in any order, is within the scope of the present disclosure.

As shown, a method 600 begins at step 602, where a processor detects a memory operation that is directed to a memory address in the PP memory address space. The PP memory address space can encompass any portion or all of a memory system associated with a PPU, such as PP memory 204 associated with PPU module 420 of FIG. 4 or a PPU module 520 of FIG. 5.

At step 604, the processor determines whether the CPU, such as a CPU in CPU dielet 412 or CPU dielet 512, is the source of the memory operation. The processor determines that the CPU is the source of the memory operation if the CPU generates the memory operation and transmits the memory operation to PP memory 204 via a high-bandwidth C2C interconnect 452 or 552 using an HDM address map. By contrast, the processor determines that the NIC, such as a NIC in NIC dielet 432 or NIC dielet 532, is the source of the memory operation if the NIC generates the memory operation and transmits the memory operation to PP memory 204 via PCIe interconnects 440 and/or 442 or 540 and/or 542 using a BAR1 address map.

If the CPU is not the source of the memory operation, then a NIC is the source of the memory operation. In such cases, the method 600 proceeds to step 606, where the processor determines whether the memory address is owned by the CPU. In so doing, the processor determines if the CPU has checked out the portion of PP memory 204 that is targeted by the memory operation.

If, at step 606, the CPU has checked out the portion of PP memory 204 that is targeted by the memory operation, then the memory address is owned by the CPU. In such cases, the method 600 proceeds to step 608, where the processor retrieves the current data corresponding to the memory address. In so doing, the processor generates and transmits an inquiry operation, referred to as a snoop operation or a probe operation, to a point of coherency associated with the CPU. The CPU generates and returns an inquiry response, referred to as a snoop response or a probe response, that includes the current data corresponding to the portion of the PP memory that is targeted by the memory operation. To ensure data coherency, the memory operation generated by the NIC is not processed until the inquiry response, including the current data, is returned.

At step 610, the NIC coherently accesses data from the memory address. The method 600 then terminates or, alternatively, returns to step 602 to process further memory operations.

Returning to step 606, if the CPU has not checked out the portion of PP memory 204 that is targeted by the memory operation, then the method 600 proceeds to step 610 where the NIC coherently accesses data from the memory address, as described above. The method 600 then terminates or, alternatively, returns to step 602 to process further memory operations.

Returning to step 604, if the CPU is the source of the memory operation, then the method 600 proceeds to step 612, where the processor determines whether the memory address is owned by the CPU. In so doing, the processor determines if the CPU has checked out the portion of PP memory 204 that is targeted by the memory operation.

If, at step 612, the CPU has not checked out the portion of PP memory 204 that is targeted by the memory operation, then the memory address is not owned by the CPU. In such cases, the method 600 proceeds to step 614, where the processor sets ownership of the memory address to the CPU.

At step 616, the CPU coherently accesses data from the memory address. The method 600 then terminates or, alternatively, returns to step 602 to process further memory operations.

Returning to step 612, if the CPU has checked out the portion of PP memory 204 that is targeted by the memory operation, then the memory address is owned by the CPU. In such cases, the method 600 proceeds to step 616 where the CPU coherently accesses data from the memory address, as described above. The method 600 then terminates or, alternatively, returns to step 602 to process further memory operations.

In sum, various embodiments include techniques for performing data transfer operations via a direct interconnect between a NIC and a PPU in self-hosted mode in a multiprocessor system. The disclosed system includes at least one CPU, at least one PPU, and at least one NIC. The CPU includes a high-bandwidth C2C interconnect to the PPU for high-speed data transfer to and from memory in the PPU and a low-bandwidth interconnect for performing configuration operations, control operations, register read and/or write operations, interrupt operations, and/or the like. The NIC has also has an interconnect to the PPU for transfer to and from memory in the PPU. With this system configuration, the low-bandwidth interconnect from the CPU to the PPU and the interconnect from the NIC to the PPU can be coupled to the PPU via a switch. The low-bandwidth interconnect from the CPU to the PPU does not negatively impact the throughput of the interconnect from the NIC to the PPU. Further, the interconnect from the NIC to the PPU does not negatively impact the throughput of the high-bandwidth interconnect from the CPU to the PPU. With the disclosed techniques, the memory in the PPU can be addressed via two distinct page-table translations utilizing two distinct address maps, a first page-table translation utilizing a first address map employed by the CPU and a second page-table translation utilizing a second address map employed by the NIC. The disclosed techniques provide a PPU hardware-enforced coherency mechanism to resolve potential coherency issues resulting from accessing the memory in the PPU via two distinct page-table translations utilizing two distinct address maps.

At least one technical advantage of the disclosed techniques relative to the prior art is that, with the disclosed techniques, a NIC can communicate with a PPU via a direct interconnect at higher data transfer rates relative to conventional techniques where data between the NIC and the PPU is transferred via a CPU. Because the NIC transfers data directly to the PPU, the throughput is not constrained by a lower-bandwidth interconnect on the CPU. Further, because the NIC does not consume bandwidth of the interconnects on the CPU, the CPU can perform data transfers and other data operations at higher throughput relative to conventional techniques that share CPU interconnect bandwidth with NIC data transfers. These advantages represent one or more technological improvements over prior art approaches.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing data transfer operations in a multiprocessor system, the method comprising:
accessing, by a network controller, a first memory of a first processor via a first interconnect using a first address map;
accessing, by a second processor, the first memory of the first processor via a second interconnect using a second address map; and
accessing, by the second processor, a second memory of the first processor via a third interconnect,
wherein the first interconnect is coupled to the third interconnect.

2. The computer-implemented method of claim 1, wherein accessing, by the network controller, the first memory of the first processor via the first interconnect comprises:
determining that at least a portion of the first memory is owned by the second processor;
transmitting a snoop operation to the second processor; and
receiving a response to the snoop operation from the second processor that includes data stored in the at least the portion of the first memory.

3. The computer-implemented method of claim 2, wherein accessing, by the network controller, the first memory of the first processor via the first interconnect further comprises:
in response to receiving the response to the snoop operation, transmitting an acknowledgement to the network controller that the data stored in the at least the portion of the first memory is available.

4. The computer-implemented method of claim 3, wherein the second processor maintains ownership of the at least the portion of the first memory pending receiving a transaction complete acknowledgment associated with the first interconnect.

5. The computer-implemented method of claim 1, wherein accessing, by the network controller, the first memory of the first processor via the first interconnect comprises:
performing a first write operation via the first interconnect that is directed to a first portion of the first memory; and
performing a second write operation via the first interconnect that is directed to a second portion of the first memory,
wherein an order of processing via the first interconnect is maintained between the first write operation and the second write operation.

6. The computer-implemented method of claim 5, wherein, when performing at least one of the first write operation or the second write operation, at least one of the first portion of the first memory or the second portion of the first memory is owned by the second processor.

7. The computer-implemented method of claim 1, wherein:
the first processor comprises a graphics processor, and
the second processor comprises a central processing unit.

8. The computer-implemented method of claim 1, wherein:
the first processor comprises a first dielet that is coupled to the first interconnect and a second dielet that is coupled to the second interconnect, and
the first dielet is coupled to the second dielet via a high-bandwidth interconnect.

9. The computer-implemented method of claim 1, wherein:
the first interconnect comprises a first Peripheral Component Interconnect Express (PCIe) interconnect with a first throughput, and
the third interconnect comprises a second PCIe interconnect with a second throughput.

10. The computer-implemented method of claim 9, wherein the first throughput is higher than the second throughput.

11. The computer-implemented method of claim 9, wherein the second interconnect comprises a chip-to-chip interconnect with a third throughput.

12. The computer-implemented method of claim 11, wherein the third throughput is higher than each of the first throughput and the second throughput.

13. The computer-implemented method of claim 11, wherein:
the first address map comprises a base address register (BAR) address map associated with the first PCIe interconnect, and
the second address map comprises a host-managed device memory (HDM) address map associated with the chip-to-chip interconnect.

14. A system comprising:
a first processor that includes a first memory and a second memory;
a network controller coupled to the first processor that:
accesses a first memory of a first processor via a first interconnect using a first address map; and
a second processor coupled to the first processor and the network controller that:
accesses the first memory of the first processor via a second interconnect using a second address map; and
accesses a second memory of the first processor via a third interconnect,
wherein the first interconnect is coupled to the second interconnect.

15. The system of claim 14, wherein to access the first memory of the first processor via the first interconnect, the network controller:
determines that at least a portion of the first memory is owned by the second processor;
transmits a snoop operation to the second processor; and
receives a response to the snoop operation from the second processor that includes data stored in the at least the portion of the first memory.

16. The system of claim 14, wherein:
the first processor comprises a graphics processor, and
the second processor comprises a central processing unit.

17. The system of claim 14, wherein:
the first processor comprises a first dielet that is coupled to the first interconnect and a second dielet that is coupled to the second interconnect, and
the first dielet is coupled to the second dielet via a high-bandwidth interconnect.

18. The system of claim 14, wherein:
the first interconnect comprises a first Peripheral Component Interconnect Express (PCIe) interconnect with a first throughput, and
the third interconnect comprises a second PCIe interconnect with a second throughput.

19. The system of claim 18, wherein the first throughput is higher than the second throughput.

20. The system of claim 18, wherein the second interconnect comprises a chip-to-chip interconnect with a third throughput.
